(19) United States
(12) Patent Application Publication
(10) Pub. No.: US 2011/0061414 A1
(43) Pub. Date: Mar. 17, 2011

(54) ROOFTOP MOUNTED AIR CONDITIONER

(75) Inventors: Wes McAllister, II, New Holland, PA (US); David L. Oberdorff, York, PA (US); Adolfo V. Salinas, Mount Wolf, PA (US)

(73) Assignee: CARRIER CORPORATION, Farmington, CT (US)

(21) Appl. No.: 12/876,535

(22) Filed: Sep. 7, 2010

Related U.S. Application Data
(60) Provisional application No. 61/241,511, filed on Sep. 11, 2009.

(51) Int. Cl. B60H 1/32; F25D 17/04

(52) U.S. Cl. 62/244; 62/407

(57) ABSTRACT

An air conditioning system for a passenger transit vehicle includes a rooftop mounted air conditioning module that has a low profile airflow management arrangement on the passenger compartment side of the roof of the vehicle for discharging air from and returning air to the evaporator section on the exterior side of the rooftop of the vehicle.

### CROSS REFERENCE TO RELATED APPLICATION

This application claims priority to and the benefit of U.S. Provisional Patent Application Ser. No. 61/241,511 entitled “Rooftop Mounted Air Conditioner” filed on Sep. 11, 2009. The content of this application is incorporated herein by reference in its entirety.

### FIELD OF THE INVENTION

This invention relates generally to rooftop mounted air conditioners for passenger transit vehicles and, more particularly, to a low profile arrangement within the passenger compartment for discharging supply air to and drawing return air from the passenger compartment.

### BACKGROUND OF THE INVENTION

Air conditioning modules are commonly mounted to the rooftop of passenger transit vehicles, such as for example public and private passenger buses, school buses, people mover cars, mono-rail transit cars and the like, for conditioning the air within the passenger compartment of the vehicle. Rooftop mounted air conditioning modules are also mounted on the rooftops of recreational vehicles for conditioning the air within the housing compartment of the recreational vehicle. Rooftop air conditioning modules of this type include a condenser section and an evaporator section that are housed in separate areas of the module housing. The evaporator section is in airflow communication with the passenger compartment interior to the vehicle and the condenser section is in airflow communication with the environment exterior to the vehicle.

For example, U.S. Pat. No. 5,605,055 discloses a rooftop air conditioning module for a transit bus having a rooftop-mounted housing including a set of condenser coils disposed outboard of the evaporator section. The evaporator section includes a pair of longitudinally extending evaporator coils that are disposed on opposite sides of a central return air opening in the rooftop of the bus. A plurality of evaporator fans are associated with each of the evaporator coils for drawing air from the passenger compartment of the bus through the return air opening and thence passing a first portion through the first evaporator coil and a first supply air discharge opening back into the passenger compartment and a second portion through a second supply air discharge opening back into the passenger compartment. The first supply air discharge air opening is formed in the rooftop on one longitudinally extending side of the central return air opening and the second supply air discharge opening is formed in the rooftop on the opposite longitudinally extending side of the return air opening.

It is also known to mount a generally rectangular, toroidal-like housing to the ceiling side of the rooftop of the bus with the open center of the toroidal-like housing disposed about the return air opening. So positioned, the supply air discharge air openings open into the respective opposite sides of the toroidal-like housing for discharge therefrom through a plurality of outlets in the walls of the toroidal-like housing. The housing extends downwardly into the passenger compartment by several inches, typically from three to five inches. Due to the toroidal-like nature of the housing, the housing extends downwardly into the center aisle of the vehicle, consequently reducing the available headroom for passengers walking up or down the aisle. Since different bus designs have different roof contours, such one-piece generally rectangular toroidal-like housings typically are custom fit for a particular roof contour because of the relatively wide width of the housing, typically from 3½ to 4½ feet. Thus, these one-piece housing are generally not interchangeable between buses having different roof contours. Additionally, because these one-piece housings are typically from 3 to 6 feet in length, multiple technicians are required to mount the housing to the passenger compartment ceiling side of the bus roof,

### SUMMARY OF THE INVENTION

An air conditioning system for a passenger transit vehicle includes a rooftop mounted air conditioning module that has a low profile airflow management arrangement on the passenger compartment side of the roof of the vehicle for discharging air from and returning air to the evaporator section on the exterior side of the rooftop of the vehicle.

An air conditioning system is provided for a transit vehicle having a passenger compartment having a rooftop extending longitudinally over the passenger compartment, with the rooftop having a first and a second laterally spaced supply air opening passing therethrough and a return air opening passing therethrough. The air conditioning system includes an air conditioning module disposed atop the rooftop of the vehicle in operative association with the first and second supply air openings whereby air from the passenger compartment passes through the return air opening into the air conditioning module and back into the passenger compartment through the first and second supply air openings, a first supply air discharge plenum housing disposed within the passenger compartment in juxtaposition with the first supply air opening, a second supply air discharge plenum housing disposed within the passenger compartment in juxtaposition with the second supply air opening; and a grille disposed in juxtaposition with the return air opening. The grille may be housed in a low profile frame disposed within the passenger compartment. In an embodiment, the return air grille and frame assembly has a depth extending into the passenger compartment that is less than the depth by which either of the first and second supply air discharge plenum housings extend into the passenger compartment. In an embodiment, the first and second supply air discharge plenum housings have a depth of less than about 3 inches, and the grille and frame assembly, which may be disposed centrally between the first and second supply air discharge openings, has a depth of less than about 1 inch.

Each of the first and second supply air discharge plenum housings may include a generally rectangular upper perimetral flange, a lower floor panel disposed in spaced relationship below the perimetral flange, a pair of longitudinally extending side walls depending from opposite longitudinal sides of the perimetral flange to opposite longitudinal sides of the floor panel, and a pair of laterally extending side walls depending from opposite lateral sides of the perimetral flange to opposite lateral sides of the floor panel. In an embodiment, each of the side walls depends inwardly from the upper perimetral flange at an included angle of about 45 degrees. At least one of the floor panel and the side walls has at least one air outlet opening therein. In an embodiment, each of the floor panel and the side walls has at least one air outlet opening therein. In an embodiment, the first and second supply air discharge plenum housings are interchangeable.

In an aspect of the invention, a supply air discharge plenum arrangement is provided for a rooftop mounted air conditioning system for a passenger transit vehicle including a first supply air discharge plenum housing for disposition within the passenger compartment in juxtaposition with one of a first and second supply air openings, and a second supply air discharge plenum housing for disposition within the passenger compartment in juxtaposition with the other of the first and second supply air openings. The first and second supply air discharge plenum housings each have at least one air outlet provided therein. The first and second supply air discharge plenum housings are interchangeable.

In an aspect of the invention, an airflow management arrangement is provided for a rooftop mounted air conditioning system for a transit vehicle having a passenger compartment having a rooftop extending longitudinally over the passenger compartment, the rooftop having a first and a second laterally spaced supply air openings passing therethrough and a return air opening passing therethrough, the return air opening disposed centrally between the first and second laterally spaced supply air openings. The airflow management arrangement includes a first air supply discharge plenum housing, a second air supply discharge plenum housing, and a return air grille assembly. The first supply air discharge plenum housing is for disposition within the passenger compartment in juxtaposition with one of the first and second supply air openings. The second supply air discharge plenum housing is for disposition within the passenger compartment in juxtaposition with the other one of the first and second supply air openings. Each of the first and second supply air discharge plenum housings has at least one air outlet provided therein. The return air grille assembly has a grille for disposition in juxtaposition with the return air opening and has a low profile frame disposed within the passenger compartment. The grille assembly has a depth extending into the passenger compartment that is less than a depth by which either of the first and second supply air discharge plenum housings extends into the passenger compartment.

### BRIEF DESCRIPTION OF THE DRAWINGS

For a further understanding of the disclosure, reference will be made to the following detailed description which is to be read in connection with the accompanying drawing, in which:

FIG. 1 is a perspective view of a passenger transit vehicle equipped with an air conditioning system having an air conditioning module mounted atop the roof thereof;

FIG. 2 is a plan view of the air conditioning module mounted atop the roof of a transit vehicle of FIG. 1;

FIG. 3 is a side elevation view, partly in section, of the rooftop mounted air conditioning module of FIG. 2;

FIG. 4 is a cross-sectional elevation view of the air conditioning module mounted on the rooftop of the transit vehicle as taken along line 4-4 of FIG. 3;

FIG. 5 is a plan view looking upwardly from within the passenger compartment of the transit vehicle of the airflow ducting arrangement of the air conditioning module of FIG. 4;

FIG. 6 is a perspective view of an exemplary embodiment of a supply air discharge plenum housing in accord with the invention;

FIG. 7 is a plan view of the exemplary embodiment of a supply air discharge plenum housing of FIG. 6;

FIG. 8 is a side elevation view of the supply air discharge plenum housing of FIG. 7 showing an exemplary embodiment of the longitudinally extending side walls thereof; and

FIG. 9 is an end elevation view of the supply air discharge plenum housing of FIG. 7 showing an exemplary embodiment of the laterally extending end walls thereof.

### DETAILED DESCRIPTION OF THE INVENTION

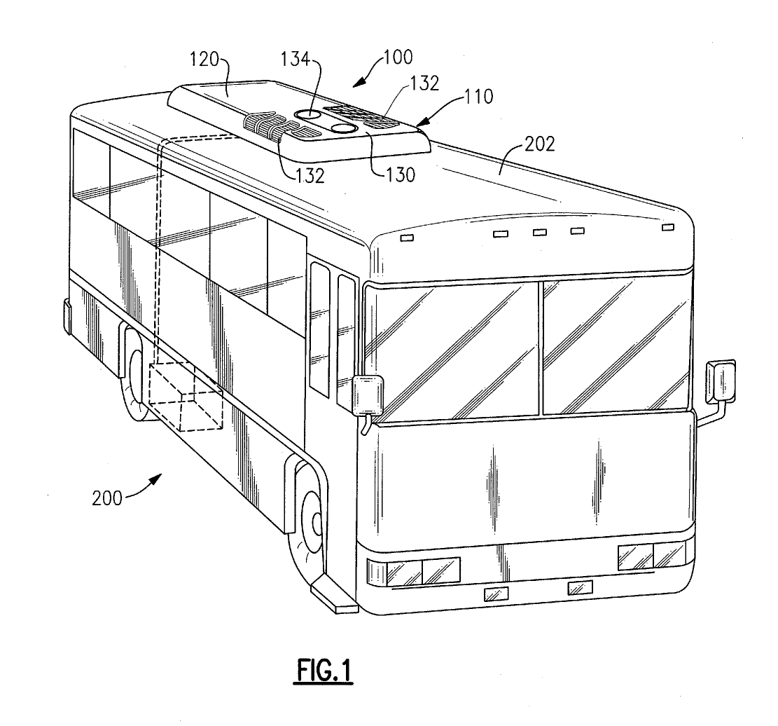

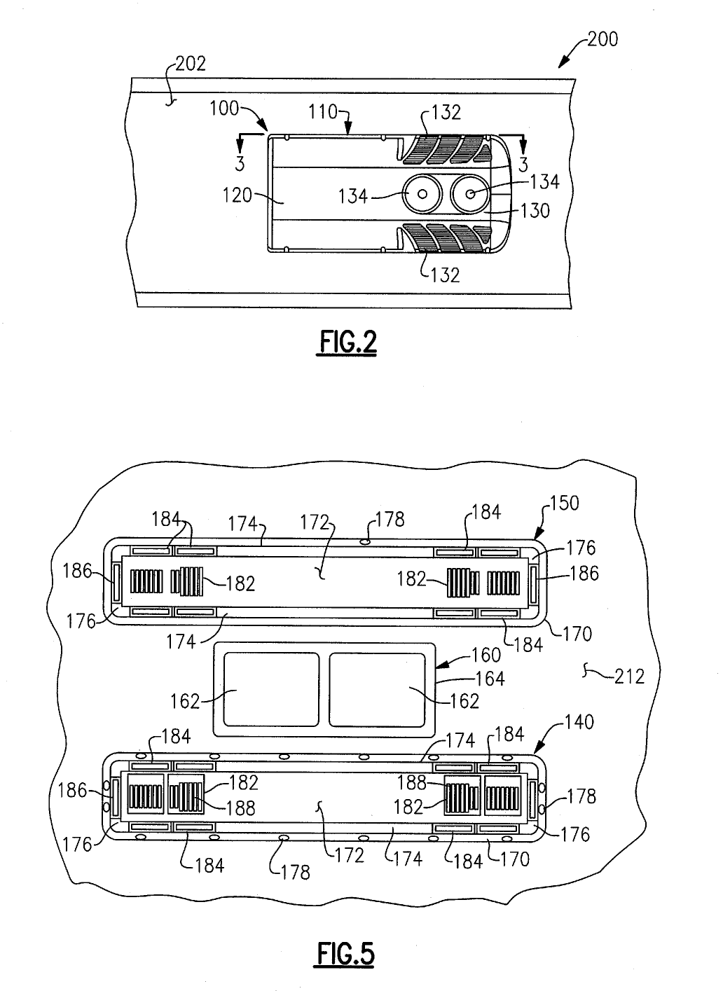

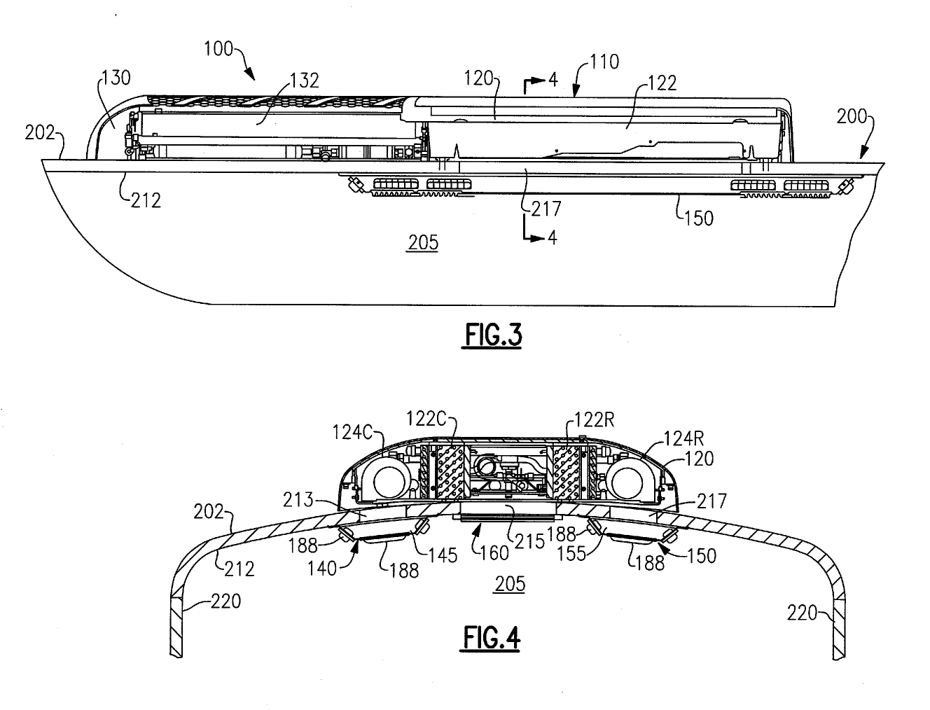

Referring initially to FIGS. 1-3 of the drawing, there is depicted a passenger transit vehicle 200 equipped with an air conditioning system including an air conditioning module 100 mounted atop the roof 202 of a transit vehicle 200 having a passenger compartment beneath the roof 202. The transit vehicle may be a bus, such as for example a school bus or public transportation bus, a people mover car, a mono-rail car or other passenger transit vehicle wherein it is desired to condition the air within the passenger compartment of the transit vehicle.

The air conditioning module 100 includes an evaporator module 120 and a condenser module 130 disposed within a longitudinally extending housing 110 mounted to the roof 202 of the transit vehicle 200. In the depicted embodiment, the evaporator module 120 is disposed aft, that is toward the rear end of the transit vehicle 200, of the condenser module 130. However, it is to be understood that in another embodiment the condenser module 130 and the evaporator module 120 may be reversed, that is the evaporator module 120 may be disposed forward of the condenser module 130. Further, in another embodiment, the condenser coils 132 may be disposed outboard of the evaporator coils 122, such as in the aforementioned U.S. Pat. No. 5,605,055. The specific arrangement within the rooftop mounted air conditioning module 100 of the evaporator coils and the condenser coils relative to each other is not particularly germane to application of the supply air plenum arrangement and the airflow management arrangement disclosed herein and those skilled in the art will recognize that the supply air plenum arrangement and the airflow management arrangement disclosed herein may be applied to various designs of rooftop mounted air conditioning modules.

In the depicted embodiment, the condenser module 130 includes a pair of longitudinally extending condenser coils 132 and a pair of condenser fans or blowers 134 for moving outdoor air across the condenser coils 132 in heat exchange relationship with a refrigerant circulating through the condenser coils. It is to be understood, however, that the design of the condenser module 130 is not germane to the invention and that persons of ordinary skill in the art will recognize other arrangements of the condenser coils and the condenser fans that may be used in the air conditioning module 100. The condenser module 130 is disposed in the forward region of the housing 110 and isolated from the passenger compartment 205 of the transit vehicle 200.

The air conditioning system also includes a refrigerant vapor compressor (not shown) that may be housed, typically together with a prime mover (not shown) for driving the compressor, in a compartment 250 remotely from the roof top mounted air conditioning module 100. Alternatively, the refrigeration compressor and its prime mover, for example an electric motor, may be housed within the condenser module 130. The refrigeration compressor compresses refrigerant vapor and circulates the refrigerant through a conventional closed loop refrigeration cycle circuit that includes the condenser coils 132 and a set of evaporator coils 122 housed in the evaporator module 120,

Referring now to FIG. 4 in particular, the evaporator module 120 includes at least one evaporator fan 124 in operative association with the aforementioned set of evaporator coils 122. The evaporator module 120 is isolated from the condenser module 130 and is in air flow communication with the passenger compartment 205 of the transit vehicle 200 through a return air opening 215 passing through the roof 202 of the transit vehicle 200 and a pair of supply air openings 213, 217 passing through the roof 202 of the transit vehicle 200. The return air opening 215 is centrally located between the pair of supply air openings 213, 217 with the first supply air opening 213 being located outboard of the return air opening 215 on the curbside thereof and with the second supply air opening 217 being located outboard of the return air opening 215 on the roadside thereof. The set of evaporator coils 122 includes a first longitudinally extending evaporator coil 122C and a second longitudinally extending evaporator coil 122R, both disposed within the evaporator module 120 and connected in refrigerant flow communication with the condenser coils via the refrigerant circuit.

In operation, the at least one evaporator fan 124 circulates air from the passenger compartment 205 through the return air opening 215, thence through the evaporator coils 122C, 122R, and back to the passenger compartment 205 as conditioned supply air through the first and second supply air openings 213, 217. In the depicted embodiment, the at least one evaporator fan 124 comprises a first plurality of fans 124C arrayed in a longitudinally extending row outboard of and in operative association with the first evaporator coil 122C and a second plurality of fans 124R arrayed in a longitudinally extending row outboard of and in operative association with the second evaporator coil 122R. The at least one evaporator fan 124, that is the first plurality of fans 124C and the second plurality of fans 124R, operate to draw return air from the passenger compartment 205 through the return air opening 215. The first plurality of fans 124C draws a first portion of that return air through the first evaporator coil 122C to be cooled as it passes in heat exchange relationship with the refrigerant circulating through the first evaporator coil 122C and thence supplies the conditioned air back to the passenger compartment 205 through the first supply air opening 213. Similarly, the second plurality of fans 124R draws a second portion of that return air through the second evaporator coil 122R to be cooled as it passes in heat exchange relationship with the refrigerant circulating through the second evaporator coil 122R and thence supplies the conditioned air back to the passenger compartment 205 through the second supply air opening 217.

In the depicted embodiment, the first plurality of fans 124C comprise squirrel cage blowers disposed in juxtaposition with the first supply air opening 213 so as to discharge conditioned air downwardly through the first supply air opening 213, and the second plurality of fans 124R comprise squirrel cage blowers disposed in juxtaposition with the second supply air opening 217 so as to discharge conditioned air downwardly through the second supply air opening 217. However, it is to be understood that throughout this application, the term fan is used in the generic sense to refer to fans or blowers, whether of the axial, centrifugal, squirrel cage, or other type, as well as other types of air movers, whether used in connection with the evaporator module 120 and the condenser module 130.

The roof 202 of the bus 200 covers the passenger compartment 205 and has a longitudinal expanse extending along the longitudinal axis of the bus 200 between the front and back of the passenger compartment 205 and a lateral expanse extending transversely to the longitudinal axis of the bus 200 between the side walls 220 of the passenger compartment 205. Referring now to FIGS. 4 and 5, the air conditioning system includes a three-piece airflow management arrangement including a first supply air discharge plenum housing 140, a second supply air discharge plenum housing 150, and a return air grill assembly 160 on the passenger compartment ceiling side 212 of the roof 202. The first and second supply air discharge plenum housings 140, 150, which formed a supply air plenum arrangement, are disposed on opposite sides of the longitudinal axis and in spaced relationship, equally spaced from the longitudinal axis of the transit vehicle 200. The first supply air discharge plenum housing 140 is disposed in juxtaposition with the first supply air opening 213 and defines a plenum 145 for receiving the supply air passing from the evaporator module 120 through the first supply air opening 213. The second supply air discharge plenum housing 150 is disposed in juxtaposition with the second supply air opening 217 and defines a plenum 155 for receiving the supply air passing from the evaporator module 120 through the second supply air opening 217.

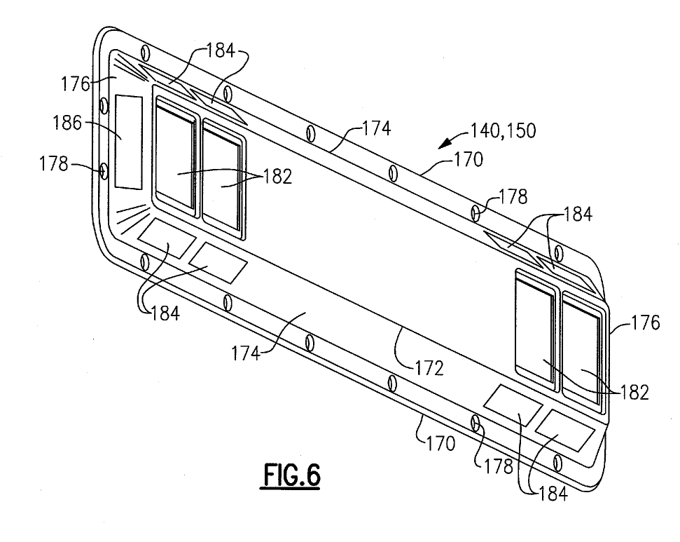

Each of the first supply air discharge plenum housing 140 and the second supply air discharge plenum housing 150 have at least one air outlet 182, 184, 186 therein establishing air flow communication between the discharge air plenum, 145, 155, respectively, and the passenger compartment 205. In the depicted embodiment, as best seen in FIG. 5-9, the first supply air discharge plenum housing 140 has a pair of air outlets 182 in the floor panel 172 thereof at each end of the floor panel, a pair of air outlets 184 at each end of each of the longitudinally extending side walls 174, and at least one air outlet 186 in each of the laterally extending side walls 176. Similarly, the second supply air discharge plenum housing 150 has a pair of air outlets 182 in the floor panel 172 thereof at each end of the floor panel, a pair of air outlets 184 at each end of each of the longitudinally extending side walls 174, and at least one air outlet 186 in each of the laterally extending side walls 176. The air outlets 182, 184, 186 may include a set of louvers or flow guides 188 for directing the supply air discharging therethrough from the respective plenums 145, 155 into the passenger compartment 205. The louvers or guide members, which for purposes of illustration are shown in detail in FIG. 5 only with respect to the air outlets 182 but may also be installed in air outlets 184 (see FIG. 4) and air outlets 186, may be selectively positionable or fixed positioned. The return air grille assembly 160 includes generally rectangular frame 164 having a central laterally extending member 166 and supporting a pair of grillwork panels 162 through which return air drawn from the passenger compartment 205 passes into the return air opening 215.

The return air grille assembly 160 is disposed centrally between the first supply air discharge plenum housing 140 and the second supply air discharge housing 150 in juxtaposition with and beneath the return air opening 215 in the roof 210. The first and second supply air discharge plenum housings 140 and 150 have a relatively low profile and the return air grille assembly has a very low profile. By relatively low profile, it is meant that the first and second supply air discharge plenum housings extend downwardly from the ceiling 212 into the passenger compartment 205 by a maximum depth of three inches (7.6 centimeters) or less. By a very low profile, it is meant that the return air grille assembly 160 extends downwardly from the ceiling 212 into the passenger compartment 205 by a maximum depth of about one inch (about 2.5 centimeters). Thus, in comparison to the aforementioned prior art generally rectangular, toroidal-like, one-piece housings of the prior art that typically extend downwardly into the passenger compartment from three to five inches (7.6 to 12.7 centimeters) across the entire width of the housing, including over the center aisle, passenger headroom is increased particularly over the center aisle where the return air grille assembly 60 extends downwardly into the passenger compartment by less than about one inch about 2.54 centimeter). The resultant increase in headroom due to the very low profile of the return air grill assembly 160 over the center aisle is highly desirable as it facilitates movement of passengers along the center aisle.

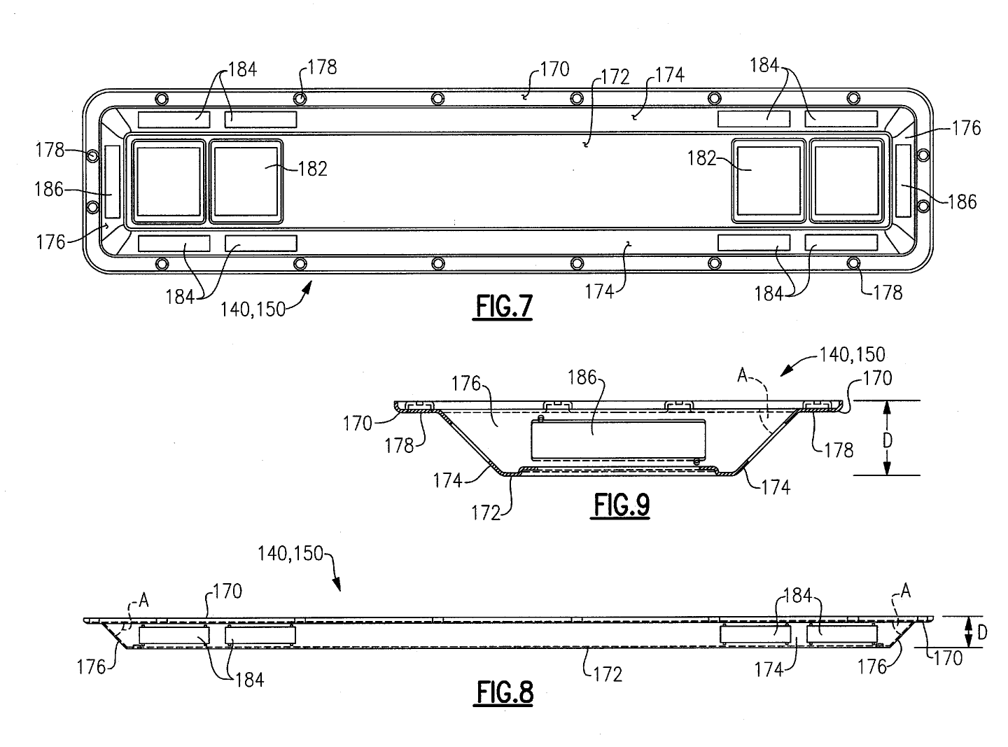

Referring now to FIGS. 5-9, respectively, an exemplary embodiment of the supply air discharge plenum housing 140, 150 are shown in a perspective view, a plan view, a longitudinal side elevation view and a lateral side wall elevation view. It should be noted that the views shown in FIGS. 7-9 are not drawn to a common scale, the view in FIG. 9 being enlarged for illustration purposes relative to the views shown in FIGS. 7 and 8. The first and second supply air discharge plenum housings 140, 150 may include a generally rectangular upper perimetral flange 170, a lower floor panel 172 disposed in spaced relationship below the perimetral flange 170, a pair of longitudinally extending side walls 174 depending from opposite longitudinal sides of the perimetral flange 170 to opposite longitudinal sides of the floor panel 172, and a pair of laterally extending side walls 176 depending from opposite lateral sides of the perimetral flange 170 to opposite lateral sides of the floor panel 172. In an embodiment, each of the side walls 174, 176 depends inwardly from the upper perimetral flange at an included angle, A, of about 45 degrees.

At least one of the floor panel 172 and the side walls 174, 176 has at least one air outlet opening therein. In depicted exemplary embodiment, the floor panel 172 has a pair of air outlets 182 opening therethrough in each of the longitudinal ends of the floor panel, each of the longitudinally extending side walls has a pair of air outlets 184 opening therethrough at each longitudinal end thereof, and the laterally extending side walls side has at least one air outlet 186 opening therethrough. A plurality of mounting holes 178 may be provided in the perimetral flange 170 at spaced intervals about the perimeter of the flange 170 through which bolts, screws or other fasteners (not shown) may be inserted for securing the supply air discharge plenum housing 140, 150 to the ceiling 212 of the transit vehicle 200.

It should be noted that, in the exemplary embodiment depicted in FIGS. 5-9, the first and second supply air discharge plenum housings 140, 150 are interchangeable relative to each other. Additionally, due to the relatively narrow width, that is the lateral dimension, of the supply air discharge plenum housings 140, 150, compared to the width of the passenger compartment 205 of the transit vehicle 200, the supply air discharge plenum housings 140, 150 may generally be interchanged from one vehicle to another vehicle requiring supply air discharge plenum housings of the same length, irrespective of the particular contour of the roof of the vehicle 200. Typically, the supply air discharge plenum housings 140, 150 has a width, that is a lateral dimension, of about fifteen (15) inches (about 37 centimeters) and a length, that is a longitudinal dimension, of about three (3) to six (6) feet (about meters to about meters). As noted previously, the supply air discharge plenum housings 140, 150 are low profile in that the depth, D, of thereof is less than a three inches (about 7.6 centimeters).

The terminology used herein is for the purpose of description, not limitation. Specific structural and functional details disclosed herein are not to be interpreted as limiting, but merely as basis for teaching one skilled in the art to employ the present invention. While the present invention has been particularly shown and described with reference to the exemplary embodiments as illustrated in the drawing, it will be recognized by those skilled in the art that various modifications may be made without departing from the spirit and scope of the invention. Those skilled in the art will also recognize the equivalents that may be substituted for elements described with reference to the exemplary embodiments disclosed herein without departing from the scope of the present invention.

Therefore, it is intended that the present disclosure not be limited to the particular embodiment(s) disclosed as, but that the disclosure will include all embodiments falling within the scope of the appended claims.

We claim:

1. An air conditioning system for a transit vehicle having a passenger compartment having a rooftop extending longitudinally over the passenger compartment, the rooftop having a first and a second laterally spaced supply air openings passing therethrough and a return air opening passing therethrough, the system comprising:
an air conditioning module disposed atop the rooftop of the vehicle in operative association with the first and second supply air openings and the return air opening, whereby air from the passenger compartment passes through the return air opening into the air conditioning module and back into the passenger compartment through the first and second supply air openings;
a first supply air discharge plenum housing disposed within the passenger compartment in juxtaposition with the first supply air opening;
a second supply air discharge plenum housing disposed within the passenger compartment in juxtaposition with the second supply air opening; and
a grille disposed in juxtaposition with the return air opening and having a low profile frame disposed within the passenger compartment.

2. The air conditioning system as recited in claim 1 wherein each of the first and second supply air discharge plenum housings comprise a generally rectangular upper perimetral flange, a lower floor panel disposed in spaced relationship below the perimetral flange, a pair of longitudinally extending side walls depending from opposite longitudinal sides of the perimetral flange to opposite longitudinal sides of the floor panel, and a pair of laterally extending side walls depending from opposite lateral sides of the perimetral flange to opposite lateral sides of the floor panel.

3. The air conditioning system as recited in claim 2 wherein each at least one of the floor panel and the side walls has at least one air outlet opening therein.

4. The air conditioning system as recited in claim 2 wherein each of the floor panel and the side walls has at least one air outlet opening therein.

5. The air conditioning system as recited in claim 2 wherein each of the side walls depends from the upper perimetral flange inwardly at an included angle of about 45 degrees.

6. The air conditioning system as recited in claim 1 wherein the first and second supply air discharge plenum housings are interchangeable.

7. The air conditioning system as recited in claim 1 wherein each of the first and second supply air discharge plenum housings have a depth of less than about 3 inches.

8. The air conditioning system as recited in claim 1 wherein the at least evaporator fan comprises:
a first evaporator coil disposed laterally of the return air opening on a first side of the return air opening;
a second evaporator coil disposed laterally of the return air opening on a second side of the return air opening opposite the first side of the return air opening;
a first evaporator fan operatively associated with the first evaporator coil and having a outlet disposed in juxtaposition with the first supply air opening; and
a second evaporator fan operatively associated with the second evaporator coil and having an outlet disposed in juxtaposition with the second supply air opening.

9. A supply air discharge plenum arrangement for a rooftop mounted air conditioning system for a transit vehicle having a passenger compartment having a rooftop extending longitudinally over the passenger compartment, the rooftop having a first and a second laterally spaced supply air openings passing therethrough; comprising:
a first supply air discharge plenum housing for disposition within the passenger compartment in juxtaposition with one of the first and second supply air openings, the first supply air discharge plenum housing having at least one air outlet provided therein; and
a second supply air discharge plenum housing for disposition within the passenger compartment in juxtaposition with the other one of the first and second supply air openings, the second supply air discharge plenum housing having at least one air outlet provided therein;
the first and second supply air discharge plenum housings being interchangeable.

10. The supply air discharge plenum arrangement as recited in claim 9 wherein each of the first and second supply air discharge plenum housings comprise a generally rectangular upper perimetral flange, a lower floor panel disposed in spaced relationship below the perimetral flange, a pair of longitudinally extending side walls depending from opposite longitudinal sides of the perimetral flange to opposite longitudinal sides of the floor panel, and a pair of laterally extending side walls depending from opposite lateral sides of the perimetral flange to opposite lateral sides of the floor panel.

11. The supply air discharge plenum arrangement as recited in claim 10 wherein each of the floor panel and the side walls has at least one air outlet opening therein.

12. The supply air discharge plenum arrangement as recited in claim 10 wherein each of the side walls depends from the upper perimetral flange inwardly at an included angle of about 45 degrees.

13. The supply air discharge plenum arrangement as recited in claim 10 wherein each of the first and second supply air discharge plenum housings has a depth of less than about 3 inches.

14. An airflow management arrangement for a rooftop mounted air conditioning system for a transit vehicle having a passenger compartment having a rooftop extending longitudinally over the passenger compartment, the rooftop having a first and a second laterally spaced supply air openings passing therethrough and a return air opening passing therethrough, the return air opening disposed centrally between the first and second laterally spaced supply air openings; comprising:
a first supply air discharge plenum housing for disposition within the passenger compartment in juxtaposition with one of the first and second supply air openings, the first supply air discharge plenum housing having at least one air outlet provided therein;
a second supply air discharge plenum housing for disposition within the passenger compartment in juxtaposition with the other one of the first and second supply air openings, the second supply air discharge plenum housing having at least one air outlet provided therein; and
a return air grille assembly having a grill disposed in juxtaposition with the return air opening and having a low profile frame disposed within the passenger compartment; the grille assembly having a depth extending into the passenger compartment that is less than a depth by which either of the first and second supply air discharge plenum housings extend into the passenger compartment.

15. The airflow management arrangement as recited in claim 14 wherein the first and second supply air discharge plenum housings are interchangeable.

16. The air conditioning system arrangement as recited in claim 14 wherein the grille assembly has a depth of less than about one inch and each of the first and second supply air discharge plenum housings has a depth of less than about 3 inches

17. An air conditioning system for a transit vehicle having a passenger compartment having a rooftop extending longitudinally over the passenger compartment, the rooftop having a first and a second laterally spaced supply air openings passing therethrough and a return air opening passing therethrough, the return air opening disposed centrally between the first and second laterally spaced supply air openings, the system comprising:
an air conditioning module disposed atop the rooftop of the vehicle, the air conditioning module including at least one evaporator coil and at least one evaporator fan for circulating air from the passenger compartment through the return air opening and back into the passenger compartment through the first and second supply air openings;
a first supply air discharge plenum housing disposed within the passenger compartment in juxtaposition with the first supply air opening;
a second supply air discharge plenum housing disposed within the passenger compartment in juxtaposition with the second supply air opening; and
a grille assembly having a grille disposed in juxtaposition with the return air opening and having a low profile frame disposed within the passenger compartment, the grille assembly having a depth extending into the passenger compartment that is less than a depth by which either of the first and second supply air discharge plenum housings extend into the passenger compartment.

18. The air conditioning system as recited in claim 17 wherein the first and second supply air discharge plenum housings are interchangeable.

19. The air conditioning system arrangement as recited in claim 17 wherein the grille assembly has a depth of less than about one inch and each of the first and second supply air discharge plenum housings has a depth of less than about 3 inches.
